(19) United States
(12) Patent Application Publication
(10) Pub. No.: US 2004/0225644 A1
(43) Pub. Date: Nov. 11, 2004

(54) Method and apparatus for search engine World Wide Web crawling

(75) Inventors: Mark Steven Squillante, Pound Ridge, NY (US); Joel Leonard Wolf, Katonah, NY (US); Philip Shi-Lung Yu, Chappaqua, NY (US)

Correspondence Address: Frank Chau, Esq., F. CHAU & ASSOCIATES, LLP, 1900 Hempstead Turnpike, East Meadow, NY, 11554, US

(73) Assignee: International Business Machines Corporation

(21) Appl. No.: 10/434,971

(22) Filed: May 9, 2003

(51) Int. Cl. G06F 7/00

(52) U.S. Cl. 707/3

(57) ABSTRACT

A technique is provided for efficient search engine crawling. First, optimal crawling frequencies, as well as the theoretically optimal times to crawl each Web page, are determined. This is performed under an extremely general distribution model of Web page updates, one which includes both stochastic and generalized deterministic update patterns. Techniques from the theory of resource allocation problems which are extraordinarily computationally efficient, crucial for practicality because the size of the problem in the Web environment is immense. The second part employs these frequencies and ideal crawl times as input, creating an optimal achievable schedule for crawlers. The solution, based on network flow theory, is exact and highly efficient as well.

### CROSS REFERENCE TO RELATED APPLICATIONS

This application is related to “Method and Apparatus for Web Crawler Data Collection,” by Squillante et al., Attorney Docket No. YOR920030081US1, copending U.S. patent application Ser. No. 10/______, filed herewith, which is incorporated by reference herein in its entirety.

### BACKGROUND OF THE INVENTION

1. Field of the Invention

The present invention relates generally to information searching, and more particularly, to techniques for providing efficient search engine crawling.

2. Background of the Invention

Search engines play a pivotal role on the World Wide Web (“Web”). Every day, millions of people rely on search engines to quickly and accurately retrieve relevant information. Without search engines, surfing the Web would be a nearly impossible task.

To facilitate searching, search engines often employ crawlers (also called “spiders” or “robots” (“bots”)). A crawler visits Web pages on various Web sites. Information read by a crawler is then used to generate an index from the Web pages that have been read. The index is used by the search engine to return links to pages associated with search terms entered by users.

Web pages are frequently updated by their owners, sometimes modestly and sometimes significantly. Studies have shown that 23 percent of Web pages change daily, while 40 percent of commercial Web pages change daily. Some Web pages disappear completely, and a half-life of 10 days for Web pages has been observed. Data gathered by a search engine during its crawls can thus quickly become stale, or out of date. As a result, crawlers must regularly revisit Web sites to maintain freshness of the search engine's data.

Although search engines perform basic functions well, it is still quite common for links to stale Web pages to be returned. For example, search engines frequently return links to Web pages that either no longer exist or which have been changed. It can be very frustrating to click on a link only to find that the result is incorrect, or worse that the page does not exist.

Given the importance of returning useful information, it would desirable and highly advantageous to provide techniques for more efficient search engine crawling that overcome the deficiencies of conventional approaches.

### SUMMARY OF THE INVENTION

The present invention provides techniques for efficient search engine crawling.

In various embodiments of the present invention, a scheme is provided to determine the optimal crawling frequencies, as well as the theoretically optimal times to crawl each Web page. It does so under an extremely general distribution model of Web page updates, one which includes both stochastic and generalized deterministic update patterns. It uses techniques from the theory of resource allocation problems which are extraordinarily computationally efficient, crucial for practicality because the size of the problem in the Web environment is immense. The second part employs these frequencies and ideal crawl times as input, creating an optimal achievable schedule for crawlers. The solution, based on network flow theory, is exact and highly efficient as well.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a block diagram illustrating exemplary components of the present invention;

FIG. 2 is a flow diagram outlining an exemplary technique for efficient search engine crawling;

FIG. 3 illustrates an exemplary embarassment-level decision tree, which indicates the way in which weights associated with each Web page can be computed;

FIG. 4 illustrates a possible graph of probability of clicking on a Web page as a function of its position and page in the search query results returned to a client;

FIG. 5 illustrates a possible freshness probability function for quasi-deterministic Web pages;

FIG. 6 is a flow diagram outlining steps involved in one of the key calculations for quasi-deterministic Web pages;

FIG. 7 is a flow diagram outlining steps involved in solving the web page allocation problem; and

FIG. 8 illustrates an exemplary transportation network to provide a crawling schedule.

### DETAILED DESCRIPTION OF PREFERRED EMBODIMENTS

According to various exemplary embodiments of the present invention, a scheme is provided to optimize the search engine crawling process. One reasonable goal is the minimization of the average level of staleness over all Web pages. However, a slightly different metric provides even greater utility. This involves an embarrassment metric, i.e., the frequency with which a client makes a search engine query, clicks on a link returned by the search engine, and then finds that the resulting page is inconsistent with respect to the query. In this context, goodness corresponds to the search engine having a fresh copy of the web page. However, badness must be partitioned into lucky and unlucky categories: The search engine can be bad but lucky in a variety of ways. In order of increasing luckiness, the possibilities are:

The Web page might be stale, but not returned to the client as a result of the query;

The Web page might be stale, returned to the client as a result of the query, but not clicked on by the client; and

The Web page might be stale, returned to the client as a result of the query, clicked on by the client, but might be correct with respect to the query anyway.

Thus, the metric under discussion only counts those queries on which the search engine is actually embarrassed. In this case, the Web page is stale, returned to the client, who clicks on the link only to find that the page is either inconsistent with respect to the original query, or (worse yet) has a broken link.

It is to be understood that the present invention may be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) that is executed via the operating system. In addition, various other peripheral devices may be connected to the computer platform such as an additional data storage device and a printing device.

It is to be further understood that, because some of the constituent system components and method steps depicted in the accompanying Figures are preferably implemented in software, the actual connections between the system components (or the process steps) may differ depending upon the manner in which the present invention is programmed. Given the teachings herein, one of ordinary skill in the related art will be able to contemplate these and similar implementations or configurations of the present invention.

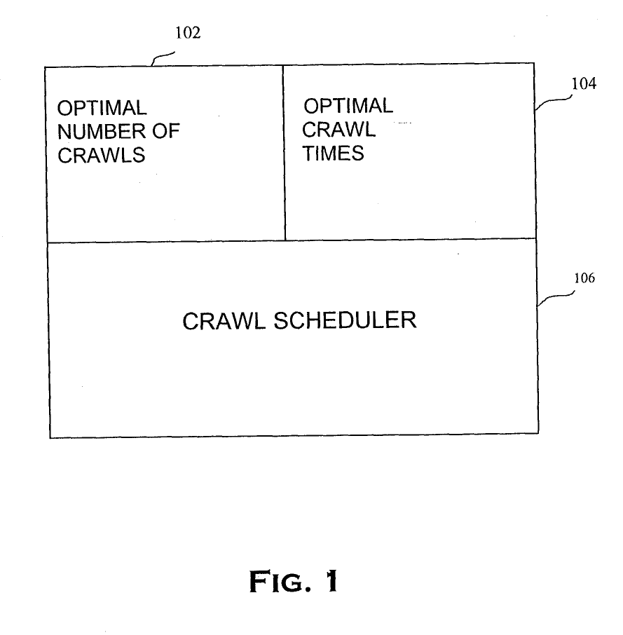

Referring to FIG. 1, a block diagram illustrating exemplary components of the present invention is shown.

A crawler optimizer 101 determines an optimal number of crawls for each Web page over a fixed period of time called a scheduling interval, as well as determining the theoretically optimal (ideal) crawl times themselves. These two problems are highly interconnected. The same basic scheme can be used to optimize either the staleness or embarrassment metric. The present invention supports models in which the updates are fully stochastic. Another important model supported by the present invention is motivated by, for example, an information service that updates its Web pages at certain times of the day, if an update to the page is necessary. This case, called quasi-deterministic, is characterized by Web pages whose updates might be characterized as somewhat more deterministic, in the sense that there are fixed potential times at which updates might or might not occur.

Web pages with deterministic updates are a special case of the quasi-deterministic model. Furthermore, the crawling frequency problem can be solved under additional constraints which make its solution more practical in the real world. For example, one can impose minimum and maximum bounds on the number of crawls for a given web page. The latter bound is important because crawling can actually cause performance problems for web sites.

The other component of the proposed invention, called a crawler scheduler 102, employs as its input the output from the crawler frequency optimizer 101. (Again, this comprises the optimal numbers of crawls and the ideal crawl times). It then finds an optimal achievable schedule for the crawlers themselves. This part of the invention is based on network flow theory, and can be posed specifically as a transportation problem. Moreover, one can impose additional real-world constraints, such as restricted crawling times for a given Web page.

1. Invention Overview

Denote by N the total number of Web pages to be crawled, which shall be indexed by i. Consider a scheduling interval of length T as a basic atomic unit of decision making. These scheduling intervals repeat every T units of time, and the invention will make decisions about one scheduling interval using both new data and the results from the previous scheduling interval. Let R denote the total number of crawls possible in a single scheduling interval.

Assume that the time intervals between updates of page i follow an arbitrary distribution function Gᵢ(●) with mean λᵢ⁻¹>0. Suppose Web page i will be crawled a total of xᵢ times during the scheduling interval [0,T] (where xᵢ is a non-negative integer less than or equal to R), and suppose these crawls occur at times 0≦t_{i,1}<t_{i,2}< . . . <t_{i,x}_{ᵢ}≦T. The invention is based on computing a time-average staleness as:

$${a}_{i} ( {t}_{i , 1} , … , {t}_{i , {x}_{i}} ) = \frac{1}{T} {\sum }_{j = 0}^{{x}_{i}} {\int }_{{t}_{i , j}}^{{t}_{i , j + 1}} ( 1 - {λ}_{i} {\int }_{0}^{∞} {\overline{G}}_{i} ( t - {t}_{i , j} + v ) ⅆ v ) ⅆ t . \qquad ( 1 )$$

where \overline{G}ᵢ(t)≡1−Gᵢ(t) is the tail distribution of interupdate times.

The times t_{i,1}, . . . , t_{i,x}_{ᵢ} should be chosen so as to minimize the time-average staleness estimate aᵢ(t_{i,1}, . . . , t_{i,x}_{ᵢ}), given that there are xᵢ crawls of page i. Deferring the question of how to find the optimal values t_{i,1}*, . . . , t_{i,x}_{ᵢ}*, define the function Aᵢ by setting

Aᵢ(xᵢ)=aᵢ(t_{i,1}*, . . . , t_{i,x}_{ᵢ}*). (2)

Thus, the domain of this function Aᵢ is the set {0, . . . , R}.

While one would like to choose xᵢ as large as possible, there is competition for crawls from other Web pages. Taking all web pages into account, one goal of the invention therefore is to minimize the objective function

$${\sum }_{i = 1}^{N} {w}_{i} {A}_{i} ( {x}_{i} ) \qquad ( 3 )$$

subject to the constraints

$${\sum }_{i = 1}^{N} {x}_{i} = R , \qquad ( 4 )$$

xᵢ ε {mᵢ, . . . , Mᵢ}. (5)

Here the weights wᵢ will determine the relative importance of each Web page i. The non-negative integers mᵢ≦Mᵢ represent the minimum and maximum number of crawls possible for page i. They could be 0 and R respectively, or any values in between. Practical considerations will dictate these choices.

A complete description of the invention may include the additional steps of:

Comparing the weights wᵢ for each Web page i.

Computing the functional forms aᵢ and Aᵢ for each Web page i.

Solving the resulting Web page crawler allocation problem in a highly efficient manner.

Scheduling the crawls in the time interval T.

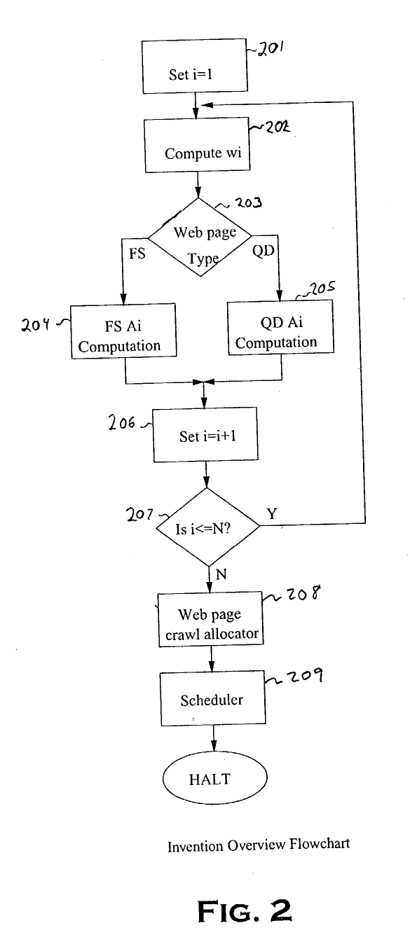

Referring to FIG. 2, a flow diagram outlining an exemplary overall technique for efficient search engine crawling is illustrated.

In step 201, i is initialized to 1. In step 202, the weight wᵢ for Web page i is computed. This step is refined in subsection 2. In step 203, it is determined whether the Web page is fully stochastic (denoted FS) or quasi-deterministic (denoted QD). Then, in either step 204 or step 205, the appropriate computation for Aᵢ is accomplished. These steps differ depending on the type of Web page, and are further refined in subsections 3 and 4, respectively. In step 206, i is incremented, and in step 207 i is tested agains N. If i≦N, control returns to step 202; otherwise, it proceeds to step 208, where the Web crawl allocation problem is solved. This step is further refined in subsection 5. In step 209, the Web page crawler problem is solved. This step is further refined in subsection 6.

2. Computing Weights wᵢ

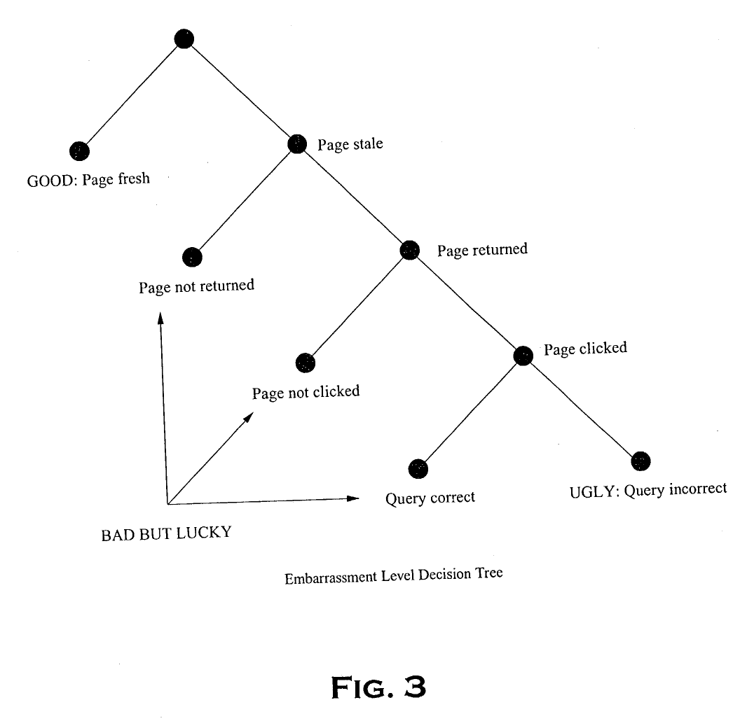

FIG. 3 illustrates a decision tree tracing the possible results for a client making a search engine query. Fix a particular Web page i in mind, and follow the decision tree down from the root to the leaves. The invention chooses weights which will indicate the level of embarrassment to the search engine.

The first possibility is for the page to be fresh. In this case, the Web page will not cause embarrassment. So, assume the page is stale. If the page is never returned by the search engine, there again can be no embarrassment. The search engine is lucky in this case. Next, consider what happens if the page is returned. A search engine will typically organize its query responses into multiple result pages, and each of these result pages will contain the URL's of several returned Web pages, in various positions on the page. Let P denote the number of positions on a returned page (which is typically on the order of 10). Note that the position of a returned Web page on a result page reflects the ordered estimate of the search engine for the web page matching what the user wants. Let b_{i,j,k} denote the probability that the search engine will return page i in position j of query result page k. The search engine can easily estimate these probabilities, either by monitoring all query results or by sampling them for the client queries.

The search engine can still be lucky even if the Web page i is stale and returned. A client might not click on the page, and thus never have a chance to learn that the page was stale. Let C_{j,k} denote the frequency that a client will click on a returned page in position j of query result page k. These frequencies also can be easily estimated, again either by monitoring or sampling.

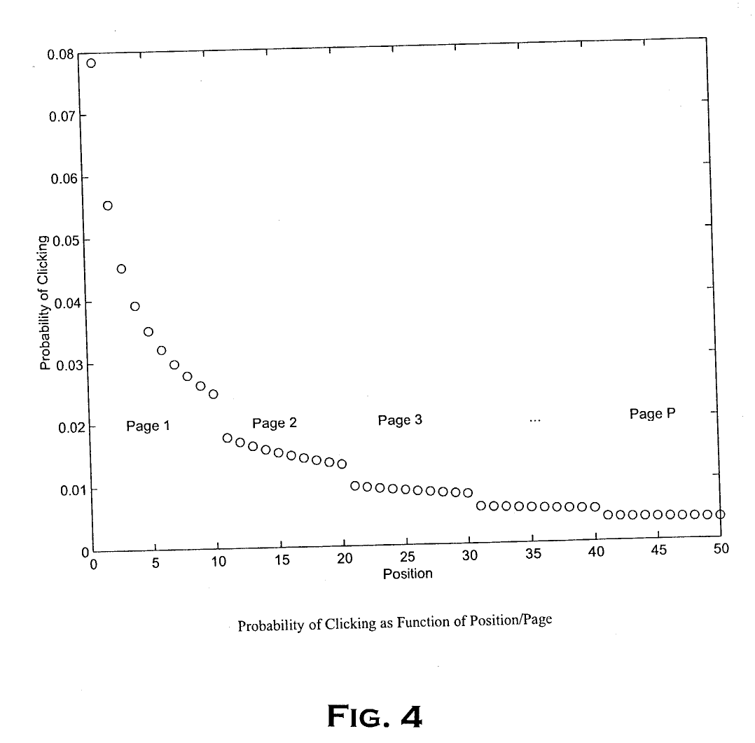

This clicking probability function might look something like FIG. 4. In any case the data can be collected by the search engine.

Even if the Web page is stale, returned by the search engine, and clicked on, the changes to the page might not cause the results of the query to be wrong. Let dᵢ denote the probability that a query to a stale version of page i yields an incorrect response. Once again, this parameter can be easily estimated.

Then one can compute the total level of embarrassment caused to the search engine by web page i as

$${w}_{i} = {d}_{i} {\sum }_{j}^{} {\sum }_{k}^{} {c}_{j , k} {b}_{i , j , k} \qquad ( 6 )$$

3. Computing the Functions Aᵢ

For concreteness, this aspect of the invention will first be described for Gᵢ(●) as exponentially distributed. Those skilled in the art will be able to understand the changes required to handle other distributions. Then the so-called quasi-deterministic case will be described. This case is appropriate for Web pages i in which there are a number of specific times u_{i,n} when the page is updated with probability k_{i,n}.

3.1 Purely Stochastic Case

Here the invention computes

$${a}_{i} ( {t}_{i , 1} , … , {t}_{i , {x}_{i}} ) = 1 + \frac{1}{{λ}_{i} T} {\sum }_{j = 0}^{{x}_{i}} ( {ⅇ}^{- {λ}_{i} ( {t}_{i , j + 1 - {t}_{i , j}} )} - 1 ) . \qquad ( 7 )$$

The optimum is known to occur at the value (T_{i,1}*, . . . , T_{i,x}_{ᵢ}*) where the derivatives are equal. The summands are all identical, and thus the optimal decision variables can be found immediately as T_{i,j}*=T/(xᵢ+1). Hence, the invention computes

$${A}_{i} ( {x}_{i} ) = 1 + \frac{{x}_{i} + 1}{{λ}_{i} T} ( {ⅇ}^{- {λ}_{i} T / ( {x}_{i} + 1 )} - 1 ) . \qquad ( 8 )$$

Moreover, for any probability distribution, the optiminim is known to occur at the value where the derivatives are equal and the summands are identical.

3.2 Quasi-Deterministic Case

In this case, there is deterministic sequence of times 0≦u_{i,1}<u_{i,2}< . . . <uᵢ, Qᵢ≦T defining possible updates for page i, together with a sequence {k_{i,1}, k_{i,2}, . . . , k_{i, Qi}} defining the probabilities that the corresponding update actually occurs. Define u_{i,0}≡0 and u_{i,Q}_{ᵢ}≡T. Those skilled in the art will appreciate that the update pattern is purely deterministic when k_{i,j}=1 for all j ε {1, . . . , Qᵢ}.

A key observation of the present invention is that all crawls should be done at the potential update times, because there is no reason to delay beyond when the update has occurred. This also implies that xᵢ≦Qᵢ+1, as there is no reason to crawl more frequently. Hence, consider the binary decision variables

$${y}_{i , j} = \{ \begin{matrix}1 , & if a crawl occurs at time {u}_{i , j} ; \\ 0 , & otherwise .\end{matrix} \qquad ( 9 )$$

If there xᵢ crawls, then Σⱼ₌₀^{Q}^{ᵢ}y_{i,j}=xᵢ.

Then, the stalesness probability function \overline{p}(y_{i,0}, . . . , y_{i,Q}_{ᵢ}, t) at an arbitrary time t is computed by the following formula.

$$\overline{p} ( {y}_{i , 0} , … , {y}_{i , {Q}_{i}} , t ) = 1 - {\prod }_{j = {J}_{i} ( t ) + 1}^{{N}_{i}^{u} ( t )} ( 1 - {k}_{i , j} ) , \qquad ( 10 )$$

where a product over the empty set, as per normal convention, is assumed to be 1.

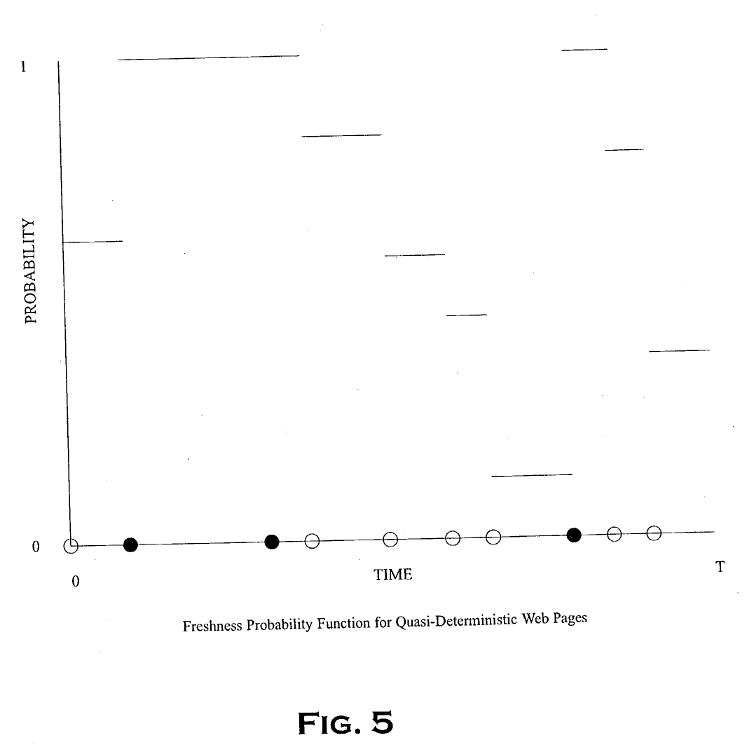

FIG. 5 illustrates a typical staleness probability function \overline{p}. For visual clarity, the freshness function 1−\overline{p} is displayed rather than the staleness function). Here the potential update times are noted by circles on the x-axis. Those which are actually crawled are depicted as filled circles, while those that are not crawled are left unfilled. The freshness function jumps to 1 during each interval immediately to the right of a crawl time, and then decreases, interval by interval, as more terms are multiplied into the product. The function is constant during each interval.

The invention then computes the corresponding time-average probability estimate as

$$\overline{a} ( {y}_{i , 0} , … , {y}_{i , {Q}_{i}} ) = {\sum }_{j = 0}^{{Q}_{i}} {u}_{i , j} [ 1 - {\prod }_{k = {J}_{i , j} + 1}^{J} ( 1 - {k}_{i , j} ) ] . \qquad ( 11 )$$

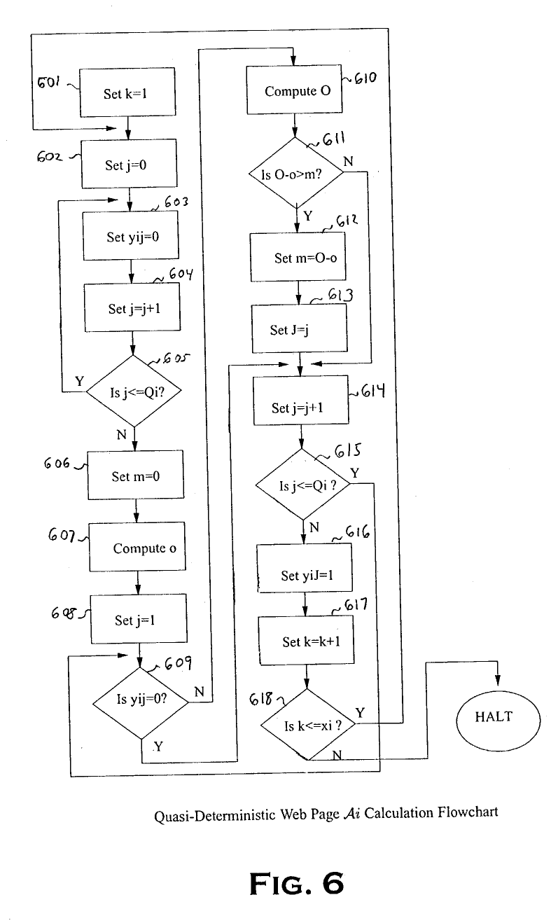

The present invention chooses the nearly optimal xᵢ crawl times as shown in FIG. 6.

First, in step 601, k is initialized to 1. In step 602, j is initialized to 0, and in step 603, y_{i,j} is initialized to 0. In step 604, j is incremented, and in step 605, it is tested against Qᵢ.

If j≦Qᵢ, control returns back to step 603; otherwise, it proceeds to step 606, where m is initialized to 0. In step 607, the value o of the objective function is computed. In step 608, j is initialized to 1, and in step 609 the value y_{i,j} is tested.

If the value y_{i,j} equals 0, control passes to step 614; otherwise, control continues to step 610. In step 610, the value O of the objective function is computed. In step 611, there is a test to see if O−o>m. If it is, in step 612, m is set equal to O−o, and in step 613, J is set equal to j.

Next, in step 614, j is incremented. In step 615, j is tested against Qᵢ. If j≦Qᵢ, then control returns back to step 609; otherwise, it proceeds with step 616, which sets yᵢ, J to 1. Then k is incremented in step 617, and tested against xᵢ in step 618. If k≦xᵢ, control returns back to step 502. Otherwise, it halts with the proper values of y_{i,j} set to 1.

4. Solving the Multiple Web Page Crawl Allocation Problem

As mentioned, the present invention finds the minimal values of

$${\sum }_{i = 1}^{N} {w}_{i} {A}_{i} ( {x}_{i} )$$

subject to the constraints Aᵢ(xᵢ)=a(t_{i,1}*, . . . , t_{i,x}_{ᵢ}*) and

$${\sum }_{i = 1}^{N} {w}_{i} {A}_{i} ( {x}_{i} ) .$$

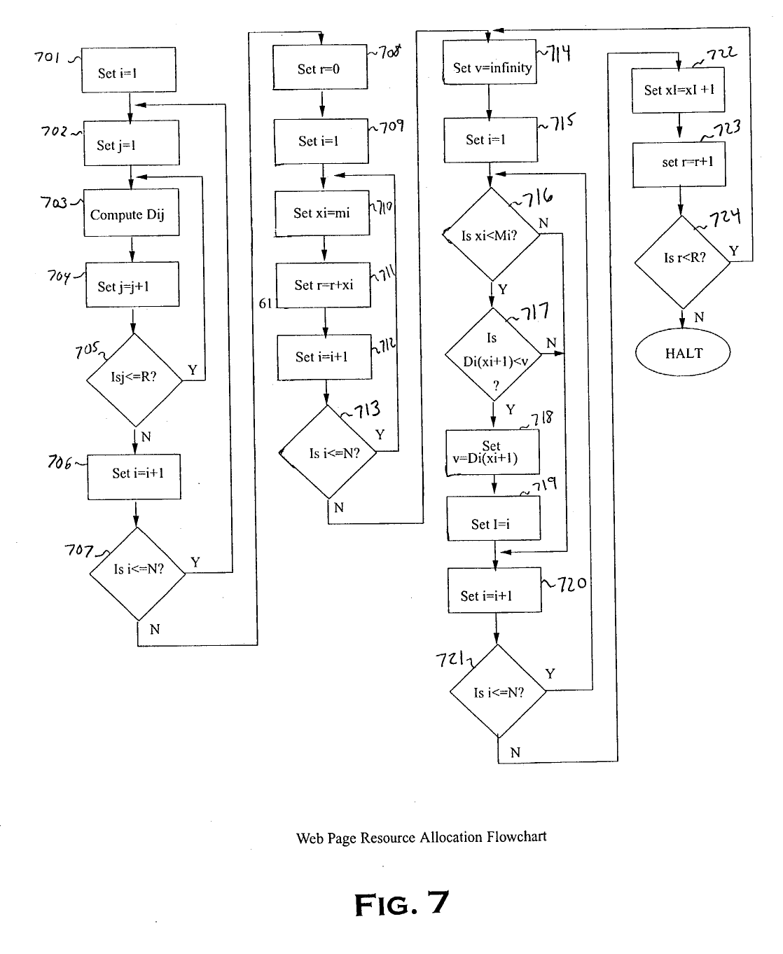

In various embodiments of the invention this can be accomplished as shown in FIG. 7.

In step 701, the value of i is initialized to 1, and in step 702, the value of j is also initialized to 1. In step 703, the value of D_{i,j} is defined to be the first difference: D_{i,j}=Fᵢ(j+1)−Fᵢ(j). In step 704, the value of j is incremented, and in step 705, the new value of j is tested.

If j≦R, control return back to step 703; otherwise, it proceeds to step 706, where i is incremented. In step 707, the new value of i is tested. If i≦N, control returns back to step 702; otherwise, it proceeds to step 708, where r is initialized to 0. In step 709, I is initialized to 1. In step 710, xᵢ is initialized to mᵢ, and in step 711, r is incremented by xᵢ. In step 712, i is incremented and in step 713 the new value of i is tested.

If i≦N, control returns back to step 710. Otherwise it proceeds to step 614 where v is initialized to ∞ (that is, set to a sufficiently large value). In step 715, i is initialized to 1. In step 716, xᵢ is tested against Mᵢ. If xᵢ<Mᵢ, then the invention proceeds to step 717, where Dᵢ(xᵢ+1) is tested against v. If Dᵢ(xᵢ+1)<v, then control proceeds to step 718, where v is set to Dᵢ(xᵢ+1). In step 719, I is set to i. In step 720, i is incremented. (This step can also be reached from step 716 if xᵢ≧Mᵢ and from step 717 if Dᵢ(xᵢ+1)≧v). In step 721, i is tested against N. If i≦N, control returns back to step 716; otherwise, it proceeds to step 722, where x_{I} is incremented. In step 723, r is incremented and in step 724, it is tested against R. If r<R, control returns back to step 714. Otherwise, it halts with the desired solution.

5. Solving the Crawler Scheduling Problem

Given that we know how many crawls should be made for each Web page, the question now becomes how to best schedule the crawls over a scheduling interval of length T. (Again, we shall think in terms of scheduling intervals of length T. We are trying to optimally schedule the current scheduling interval using some information from the last one). We shall assume that there are C possibly heterogeneous crawlers, and that each crawler k can handle Sₖ crawl tasks in time T. Thus we can say that the total number of crawls in time T is R=Σₖ₌₁^{C}Sₖ. We shall make one simplifying assumption that each crawl on crawler k takes approximately the same amount of time. Thus, we can divide the time interval T into Sₖ equal size time slots, and estimate the start time of the lth slot on crawler k by Tₖₗ=(l−1)/T for each 1≦l≦Sₖ and 1≦k≦C.

We know from the previous section the desired number of crawls xᵢ* for each web page i. Since we have already computed the optimal schedule for the last scheduling interval, we further know the start time t_{i,0} of the final crawl for web page i within the last scheduling interval. Thus we can compute the optimal crawl times t_{i,1}*, . . . , t_{i,x}_{ᵢ}* for Web page i during the scheduling interval. For the stochastic case, it is important for the scheduler to initiate each of these crawl tasks at approximately the proper time, but being a bit early or a bit late should have no serious impact for most of the update probability distribution functions we envision. Thus it is reasonable to assume a scheduler cost function for the jth crawl of page i, whose update patters follow a stochastic process, that takes S(t)=|t−t_{i,j}*|. On the other hand, for a Web page i whose update patterns follow a quasi-deterministic process, being a bit late is acceptable, but being early is not useful. So an appropriate scheduler cost function for the jth crawl of a quasi-deterministic page i might have the form

$$S ( t ) = \{ \begin{matrix}∞ , & if t < {t}_{i , j}^{*} \\ t - {t}_{i , j} , & otherwise .\end{matrix} \qquad ( 12 )$$

The problem can be posed and solved as a transportation problem in a manner described below.

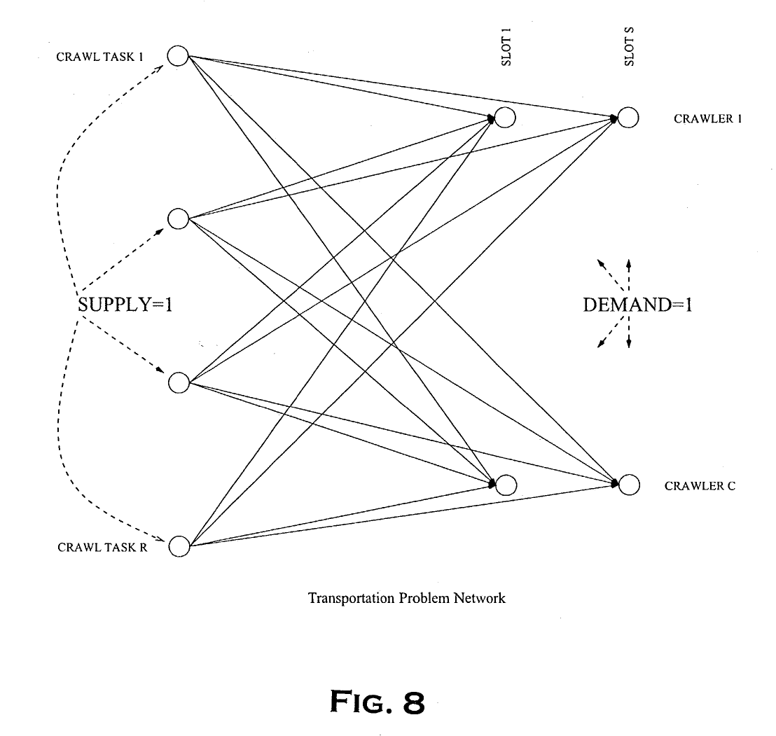

Define a bipartite network with one directed arc from each supply node to each demand node. The R supply nodes, indexed by j, correspond to the crawls to be scheduled. Each of these nodes has a supply of 1 unit. There will be one demand node per time slot and crawler pair, each of which has a demand of 1 unit. We index these by 1≦l≦Sₖ and 1≦k≦C. The cost of arc jkl emanating from a supply node j to a demand node kl is Sⱼ(Tₖₗ). FIG. 8 shows the underlying network for an example of this particular transportation problem. Assume that each can crawl the same number S=Sₖ of pages in the scheduling interval T. In the figure, the number of crawls is R=4, which equals the number of crawler time slots. The number of crawlers is C=2, and the number of crawls per crawler is S=2. Hence, R=CS.

The specific linear optimization problem solved by the transportation problem can be formulated as follows.

$$Minimize {\sum }_{i = 1}^{M} {\sum }_{j = 1}^{N} {\sum }_{k = 1}^{M} {R}_{i} ( {T}_{j k} ) {f}_{i j k} \qquad ( 13 )$$

such that

$${\sum }_{i = 1}^{M} {f}_{i j k} = 1 ∀ 1 \leq j \leq N and 1 \leq k \leq M , \qquad ( 14 )$$

fᵢⱼₖ≧0∀1≦i,k≦M and 1≦j≦N. (15)

Those skilled in the art will readily appreciate that the solution of a transportation problem can generally be accomplished efficiently. The nature of the transportation problem formulation ensures that there exists an optimal solution with integral flows, and the techniques in the literature find such a solution. This implies that each fᵢⱼₖ is binary. If fᵢⱼₖ=1, then a crawl of web page i is assigned to the jth crawl of crawler k.

If it is required to fix or restrict certain crawl tasks from certain crawler slots, this an be easily done. One simply changes the cost of the restricted directed arcs to be infinite. (Fixing a crawl task to a subset of crawler slots is the same as restricting it from the complementary crawler slots).

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method for determining search engine embarrassment, comprising:
for each of a plurality of Web pages,
(a) obtaining information regarding the probability that the Web page is stale and will be returned to and selected by a client, and
(b) computing an embarrassment level using the obtained information.

2. The method of claim 1, wherein computed embarrassment levels are used in formulating a Web crawling schedule.

3. A system for providing efficient search engine crawling, comprising:
a crawler optimizer for determining an optimal number of crawls and crawl times during a predetermined time interval for a predetermined number of Web pages; and
a crawler scheduler for determining an optimal achievable crawler schedule for a predetermined number of crawlers, using the determined number of crawls and crawl times.

4. The system of claim 3, wherein the crawler optimizer determines the optimal number of crawls and crawl times with respect to minimizing average level of embarrassment.

5. The system of claim 3, wherein the crawler optimizer determines the optimal number of crawls and crawl times using information as to whether Web pages are updated in a stochastic or quasi-deterministic manner.

6. The system of claim 3, wherein the crawler optimizer is constrained by a minimum number of crawls of Web pages during the predetermined time interval.

7. The system of claim 3, wherein the crawler optimizer is constrained by a maximum number of crawls of Web pages during the predetermined time interval.

8. The system of claim 3, wherein the crawler scheduler determines the optimal crawler schedule using a transportation network model.

9. The system of claim 3, wherein the crawler scheduler is constrained by restricted crawling times for specified Web pages.

10. A program storage device readable by a machine, tangibly embodying a program of instructions executable on the machine to perform method steps for determining levels of embarrassment, the method steps comprising:
for each of a plurality of Web pages,
(a) obtaining information regarding the probability that the Web page is stale and will be returned to and selected by a client, and
(b) computing an embarrassment level using the obtained information.

11. The program storage device of claim 10, wherein computed embarrassment levels are used in formulating a Web crawling schedule.

12. A method for determining a level of embarrassment to a search engine, comprising:
determining a level of embarrassment for each of a plurality of Web pages, the level of embarrassment for each of the plurality of Web pages determined according to
$${w}_{i} = {d}_{i} {\sum }_{j}^{} {\sum }_{k}^{} {c}_{j , k} {b}_{i , j , k}$$
where
wᵢ is the level of embarrassment for Web page i,
dᵢ is the probability a query to a stale version of wᵢ yields an incorrect response,
c_{j,k} is the frequency that a client will click on a returned page in a position j of a query result page k, and
b_{i,j,k} is the probability that the Web page i will be returned in the position j of the query result page k.
